(19) United States
(12) Patent Application Publication
(10) Pub. No.: US 2005/0184507 A1
(43) Pub. Date: Aug. 25, 2005

(54) Per-co-rate

(76) Inventor: CoRetta Dingle, Alexandria, VA (US)

Correspondence Address: CoRetta Dingle, 2007 Willow Switch Lane, Upper Marlboro, MD, 20774, US

(21) Appl. No.: 10/785,333

(22) Filed: Feb. 25, 2004

(51) Int. Cl. B42F 5/00

(52) U.S. Cl. 283/103

(57) ABSTRACT

Per-Co-rate offers a method of separating photos without the use of scissors. It is smooth perforated glossy photo paper that provides a simple and safe method of separating photos—just fold, crease and tear photo paper along perforation.

### BACKGROUND OF THE INVENTION

Other than self-adhesive photos, such methods of separating photos without the use of scissors are not known.

### FIELD OF THE INVENTION

The invention relates to a method of separating photos without the use of scissors.

### BRIEF SUMMARY OF THE INVENTION

The invention is to permit a simple and quick method of separating photos. The advantage of the invention is that it's scissor-free.

### BRIEF DESCRIPTION OF THE DRAWINGS

Referencing the accompanying drawings gives a more complete appreciation and understanding of the invention.

FIGS. 1-4 show different sizes of the smooth perforated glossy photo paper.

### DETAILED DESCRIPTION OF THE INVENTION

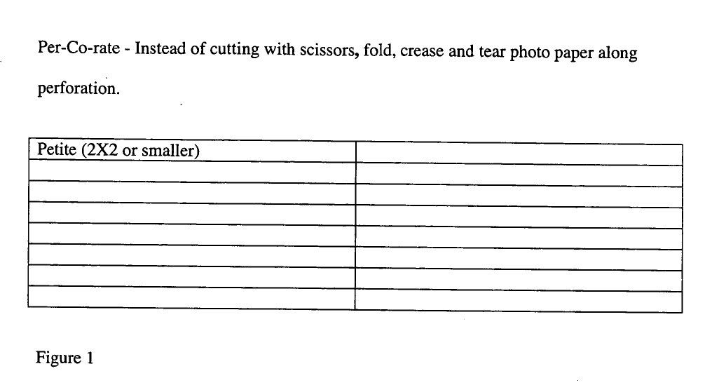

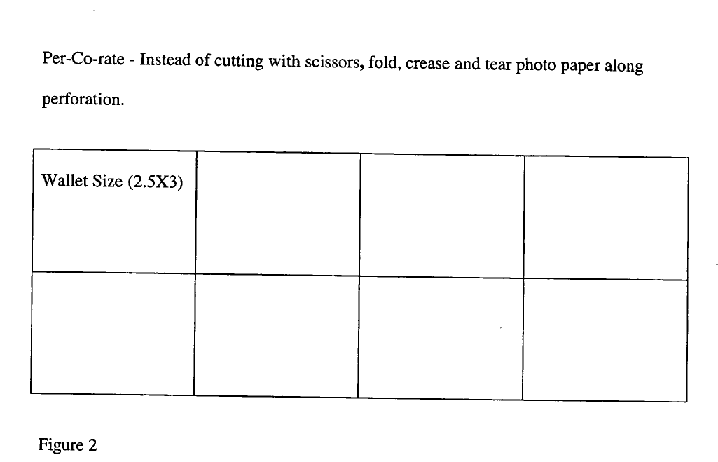

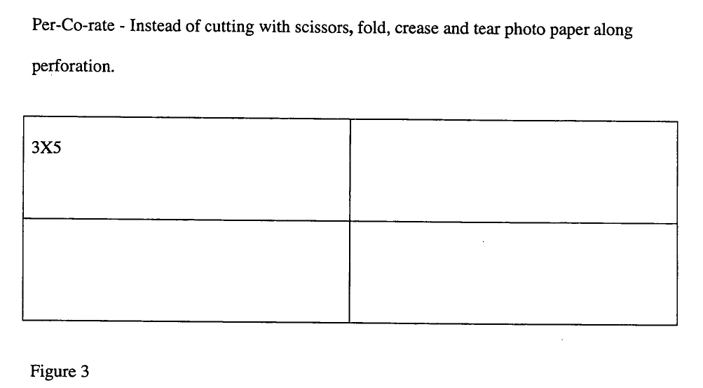

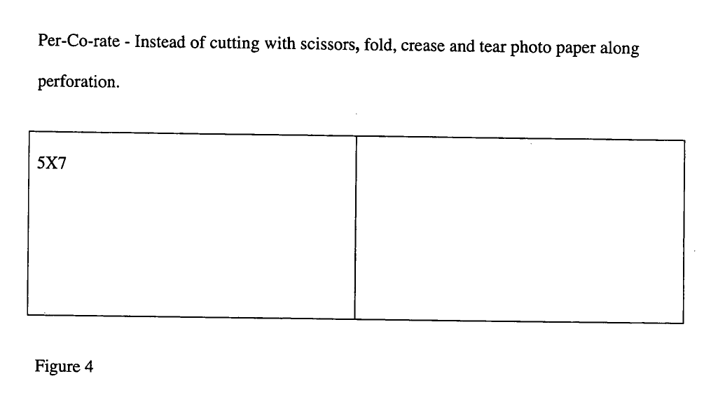

Referencing now to the drawings, elements essential for understanding the invention are shown. FIGS. 1-4 show different options of paper sizes. Per-Co-rate is smooth perforated glossy photo paper that provides a simple and safe method of separating photos—just fold, crease and tear photo paper along perforation.

1. What I claim as my invention is Per-Co-rate. It is a method of separating photos without the use of scissors.
